(19) United States
(12) Patent Application Publication
(10) Pub. No.: US 2005/0268093 A1
(43) Pub. Date: Dec. 1, 2005

(54) Method and apparatus for creating a trusted environment in a computing platform

(76) Inventor: Graeme John Proudler, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/138,921

(22) Filed: May 25, 2005

(30) Foreign Application Priority Data
May 25, 2004 (GB) 0411654.7

(51) Int. Cl. H04L 9/00

(52) U.S. Cl. 713/164

(57) ABSTRACT

A method for creating a trusted environment within a computing platform comprises the steps, performed at a trusted device, of obtaining authorisation information in relation a process having a mandatory manner of launch; launching the mandatory process in the mandatory manner if the authorisation information meets an authorisation criterion; and storing the authorisation information for additional authorisation steps.

### FIELD OF THE INVENTION

The invention relates to a method for creating a trusted environment in a computing platform.

### BACKGROUND OF THE INVENTION

In computer platforms such as those residing on mobile (cellular) telephones, upon boot-up of the platform, control of radio transmitter operation is launched. Control of the operation of the radio transmitter is a mandatory security function (MSF) in as much as it is vital that operation is controlled by specific, predetermined software as otherwise the cell can crash. As a result it is important to ensure the security of the platform for example against external intervention to avoid such an event occurring.

### BRIEF SUMMARY OF THE INVENTION

A method for creating a trusted environment within a computing platform comprises the step, performed at a trusted device, of obtaining authorisation information in relation to a process having a mandatory manner of launch: The method further comprises the steps of launching the mandatory process in the mandatory manner if the authorisation information meets an authorisation criterion and storing the authorisation information for additional authorisation steps.

### BRIEF DESCRIPTION OF THE DRAWINGS

Embodiments of the invention will now be described, by way of example only, with reference to the drawings of which:

FIG. 1 is a block diagram showing a mobile telephone computing platform as described herein;

FIG. 2 is a high level architecture diagram of privilege levels applied according to the present method;

FIG. 3 indicates functional elements present on the motherboard of a trusted computer platform;

FIG. 4 indicates the functional elements of a trusted device of the trusted computer platform of FIG. 3;

FIG. 5 illustrates the process of extending values into a platform configuration register of the trusted computer platform of FIG. 2;

FIG. 6 is a low-level architecture diagram illustrating the present method;

FIG. 7 is a flow diagram illustrating steps involved in launching an MSF; and

FIG. 8 is a flow diagram illustrating steps involved in subsequent authentication/authorisation in relation to an MSF.

### DETAILED DESCRIPTION OF THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In overview a conventional cellular telephone designated generally 100 in FIG. 1 includes a computing platform 102 controlling operation of the telephone, interfaced with the user and with an external network designated generally 108 as is well known to the skilled reader. The platform 102 includes a processor 106 and a memory 104 storing a BIOS (Basic Input/Output System) programme arranged to initialise all input/output devices upon boot-up of the platform 102 after which control is handed over to an operating system programme. Amongst the processes initialised by the BIOS programme is the radio transmitter configuration and it is desirable to ensure that this operation is controlled as a mandatory process in a secure and trusted manner.

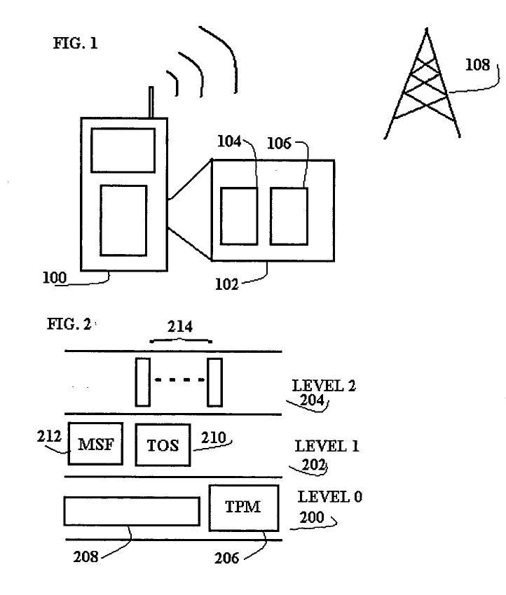

With reference to FIG. 2, the method described herein ensures both secure and authenticated boot-up by ensuring that the components that carry out the invention are ones that can be trusted to be operating in the correct manner. This is achieved by using, as the components that launch the operation, “roots-of-trust” that are protected from subversion, whether those roots-of-trust are implemented in software or firmware or hardware.

In particular the platform 102 enforces three levels of privilege, a highest level, level zero privilege 200, at which the roots-of-trust-execute; a next highest level, level one privilege 202, and a next-highest level of privilege, level two privilege, 204. By ensuring that, when the platform boots, operation is initially controlled at level zero, the mandatory security functions such as control of radio transmission are launched in the correct and predetermined manner providing enforcement of the MSFs, optimum security and creation of a trusted environment. In particular it is ensured that control is passed down upon platform boot from the highest level, level zero. As a result, security and authentication of the boot process is guaranteed at the same level of trust as can be attached to level zero.

As discussed in more detail below, a trusted device 206 comprising a Root-of-Trust-for-Measurement (RTM), and a trusted platform module (TPM) is provided at privilege level zero. The RTM is optionally configured upon platform boot to measure itself and record the results in the TPM. The RTM is optionally configured upon boot to make measurements of the TPM and record the results in the TPM. The RTM is configured upon boot to measure the next software to be loaded and record the results in the TPM. Once the RTM has finished all its measurements, the RTM loads the next software to be loaded, and passes control to that software. In this case, the next software to be loaded is the kernel 208, also in level 0. Once control has been passed to the kernel 208, it then identifies, inter alia, mandatory processes such as a mandatory security function MSF, 212 having level one privilege or a mandatory operating system itself configured to launch the MSF. The MSF can be, for example, control of radio transmission in the mobile telephone. The kernel carries out further measurements of the MSF 212 and compares those measurements with expected values verified to have been provided by a trusted third party. If the comparisons reveal that the MSF 212 is authorised by the third party, the kernel records the authorisation in the TPM 206 and launches the MSF. Otherwise the kernel 208 measures an exception handling routine, records those measurements in the TPM 206, and launches an exception handling routine.

Assuming that the MSF has been launched, the kernel may additionally launch and operate a trusted operating system TOS 210 also at level one privilege. Multiple, isolated OS's or component OS's can be operated in this manner as discussed in more detail below. The TOS 210 can then run appropriate OS applications 214 at level two privilege.

Because the trusted device obtains and compares the appropriate measurements, authorisation information is derived and launch of the MSF at least is only permitted if those measurements meet the authorisation criteria as a result of which secure, authenticated and trusted launch of the mandatory security function is ensured. In particular, this ensures that a particular, predetermined application controls radio transmission in the specific example described here because of the measurement, by the kernel, of the MSF which ensures that its use is both enforced and authenticated. Furthermore the authorisation information can be stored as discussed in more detail allowing additional authorisation (for example, further authentication) steps to be carried out if necessary. Of course the approach is applicable in the case of any type of mandatory process that is to say, any function or process the appropriate implementation of which must occur in a predetermined manner i.e. under control of a mandatory launch operation, and ensures that any such function is enforced accordingly.

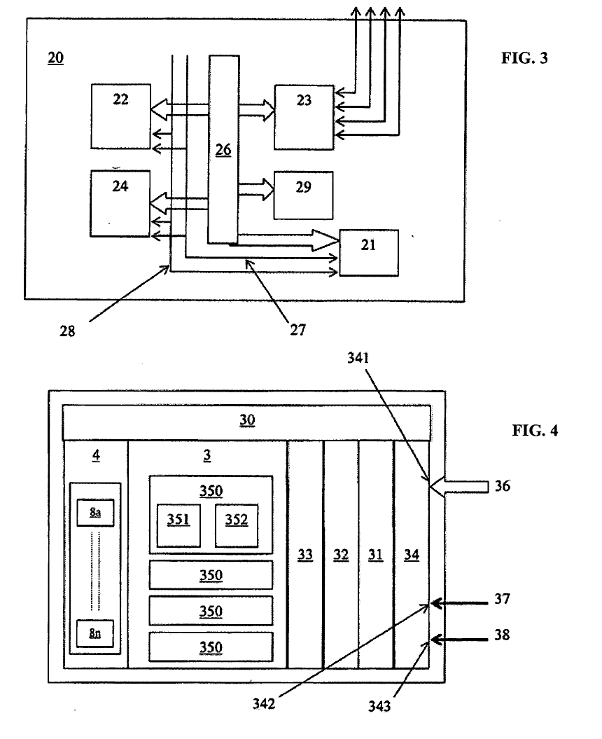

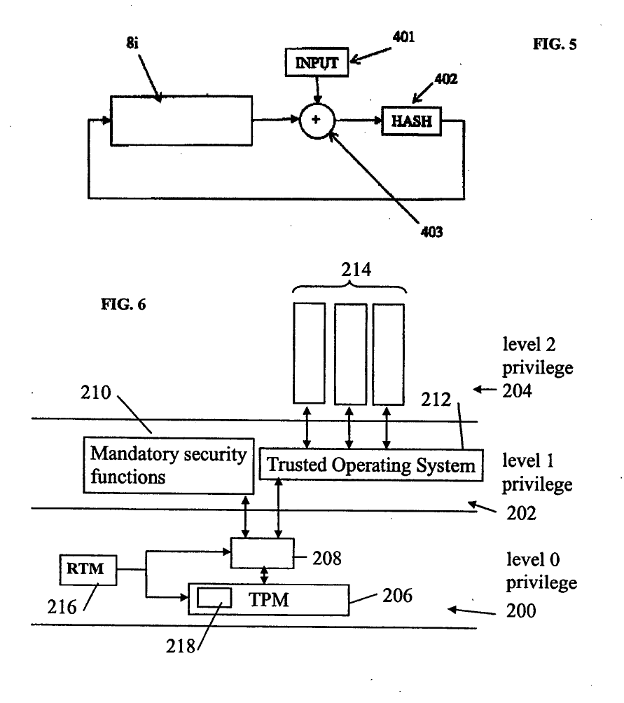

A trusted computing platform of a type generally suitable for carrying out embodiments of the present invention will be described with relevance to FIGS. 3 to 5. This description of a trusted computing platform describes certain basic elements of its construction and operation. A “user”, in this context, may be a remote user such as a remote computing entity. A trusted computing platform is further described in the applicant's International Patent Application No. PCT/GB00/00528 entitled “Trusted Computing Platform” and filed on 15 Feb. 2000, the contents of which are incorporated by reference herein.

A significant consideration in interaction between computing entities is trust—whether a foreign computing entity will behave in a reliable and predictable manner, or will be (or already is) subject to subversion. Trusted systems which contain a component at least logically protected from subversion have been developed by the companies forming the Trusted Computing Group (TCG)—this body develops specifications in this area, such are discussed in, for example, “Trusted Computing Platforms—TCPA Technology in Context”, edited by Siani Pearson, 2003, Prentice Hall PTR (“Pearson”). The implicitly trusted components of a trusted system enable measurements of a trusted system and are then able to provide these in the form of integrity metrics to appropriate entities wishing to interact with the trusted system. The receiving entities are then able to determine from the consistency of the measured integrity metrics with known or expected values that the trusted system is operating as expected.

Integrity metrics will typically include measurements of the software used by the trusted system. These measurements may, typically in combination, be used to indicate states, or trusted states, of the trusted system. In Trusted Computing Group specifications, mechanisms are taught for “sealing” data to a particular platform state—this has the result of encrypting the sealed data into an inscrutable “opaque blob” containing a value derived at least in part from measurements of software on the platform. The measurements comprise digests of the software, because digest values will change on any modification to the software. This sealed data may only be recovered if the trusted component measures the current platform state and finds it to be represented by the same value as in the opaque blob.

The skilled person will appreciate that the present invention does not rely for its operation on use of a trusted computing platform precisely as described below: embodiments of the present invention are described with respect to such a trusted computing platform, but the skilled version will appreciate that aspects of the present invention may be employed with different types of computer platform which need not employ all aspects of Trusted Computing Group trusted computing platform functionality.

A trusted computing platform of the kind described here is a computing platform into which is incorporated a trusted device whose function is to bind the identity of the platform to reliably measured data that provides one or more integrity metrics of the platform. The identity and the integrity metric are compared with expected values provided by a trusted party (TP) that is prepared to vouch for the trustworthiness of the platform. If there is a match, the implication is that at least part of the platform is operating correctly, depending on the scope of the integrity metric.

A user verifies the correct operation of the platform before exchanging other data with the platform. A user does this by requesting the trusted device to provide its identity and one or more integrity metrics. (Optionally the trusted device will refuse to provide evidence of identity if it itself was unable to verify correct operation of the platform.) The user receives the proof of identity and the identity metric or metrics, and compares them against values which it believes to be true. Those proper values are provided by the TP or another entity that is trusted by the user. If data reported by the trusted device is the same as that provided by the TP, the user trusts the platform. This is because the user trusts the entity. The entity trusts the platform because it has previously validated the identity and determined the proper integrity metric of the platform.

Once a user has established trusted operation of the platform, he exchanges other data with the platform. For a local user, the exchange might be by interacting with some software application running on the platform. For a remote user, the exchange might involve a secure transaction. In either case, the data exchanged is ‘signed’ by the trusted device. The user can then have greater confidence that data is being exchanged with a platform whose behaviour can be trusted. Data exchanged may be information relating to some or all of the software running on the computer platform. Existing Trusted Computing Group trusted computer platforms are adapted to provide digests of software on the platform—these can be compared with publicly available lists of known digests for known software. This does however provide an identification of specific software running on the trusted computing platform.

The trusted device uses cryptographic processes but does not necessarily provide an external interface to those cryptographic processes. The trusted device should be logically protected from other entities—including other parts of the platform of which it is itself a part. Also, a most desirable implementation would be to make the trusted device tamperproof, to protect secrets by making them inaccessible to other platform functions and provide an environment that is substantially immune to unauthorised modification (ie, both physically and logically protected). Since tamper-proofing is impossible, the best approximation is a trusted device that is tamper-resistant, or tamper-detecting. The trusted device, therefore, preferably consists of one physical component that is tamper-resistant. Techniques relevant to tamper-resistance are well known to those skilled in the art of security. These techniques include methods for resisting tampering (such as appropriate encapsulation of the trusted device), methods for detecting tampering (such as detection of out of specification voltages, X-rays, or loss of physical integrity in the trusted device casing), and methods for eliminating data when tampering is detected.

Although in the embodiment of FIG. 1 a trusted platform is shown in the form of a mobile telephone it will be appreciated that any appropriate mobile or static platform may provide the basis for the approach described herein, and the teachings here apply equally or equivalently.

As illustrated in FIG. 3, the motherboard 20 of a trusted computing platform includes (among other standard components) a main processor 21, main memory 22, a trusted device 24, a data bus 26 and respective control lines 27 and lines 28, BIOS memory 29 containing the BIOS program for the platform 10 and an Input/Output (IO) device 23, which controls interaction between the components of the motherboard and the keyboard 14, the mouse 16 and the VDU 18. The main memory 22 is typically random access memory (RAM). In operation, the platform 10 loads the operating system, for example Windows XP™, into RAM from hard disk (not shown). Additionally, in operation, the platform 10 loads the processes or applications that may be executed by the platform 10 into RAM from hard disk (not shown).

Typically, in a platform the BIOS program is located in a special reserved memory area. For example in a personal computer it is located in the upper 64K of the first megabyte of the system memory (addresses FØØØh to FFFFh), and the main processor is arranged to look at this memory location first, in accordance with an industry wide standard. A significant difference between the platform and a conventional platform is that, after reset, the main processor is initially controlled by the trusted device, which then hands control over to the platform-specific BIOS program, which in turn initialises all input/output devices as normal. After the BIOS program has executed, control is handed over as normal by the BIOS program to an operating system program, such as Windows XP (TM), which is typically loaded into main memory 22 from a hard disk drive (not shown). The main processor is initially controlled by the trusted device because it is necessary to place trust in the first measurement to be carried out on the trusted platform computing. The measuring agent for this first measurement is termed the root of trust of measurement (RTM) and is typically trusted at least in part because its provenance is trusted. In one practically useful implementation the RTM is the platform while the main processor is under control of the trusted device. As is briefly described below, one role of the RTM is to measure other measuring agents before these measuring agents are used and their measurements relied upon. The RTM is the basis for a chain of trust. Note that the RTM and subsequent measurement agents do not need to verify subsequent measurement agents, merely to measure and record them before they execute. This is called an “authenticated boot process”. Valid measurement agents may be recognised by comparing a digest of a measurement agent against a list of digests of valid measurement agents. Unlisted measurement agents will not be recognised, and measurements made by them and subsequent measurement agents are suspect.

The trusted device 24 comprises a number of blocks, as illustrated in FIG. 4. After system reset, the trusted device 24 performs an authenticated boot process to ensure that the operating state of the platform 10 is recorded in a secure manner. During the authenticated boot process, the trusted device 24 acquires an integrity metric of the computing platform 10. The trusted device 24 can also perform secure data transfer and, for example, authentication between it and a smart card via encryption/decryption and signature/verification. The trusted device 24 can also securely enforce various security control policies, such as locking of the user interface. In a particularly preferred arrangement, the display driver for the computing platform is located within the trusted device 24 with the result that a local user can trust the display of data provided by the trusted device 24 to the display—this is further described in the applicant's International Patent Application No. PCT/GB00/02005, entitled “System for Providing a Trustworthy User Interface” and filed on 25 May 2000, the contents of which are incorporated by reference herein.

Specifically, the trusted device in this embodiment comprises: a controller 30 programmed to control the overall operation of the trusted device 24, and interact with the other functions on the trusted device 24 and with the other devices on the motherboard 20; a measurement function 31 for acquiring a first integrity metric from the platform 10 either via direct measurement or alternatively indirectly via executable instructions to be executed on the platform's main processor; a cryptographic function 32 for signing, encrypting or decrypting specified data; an authentication function 33 for authenticating a smart card; and interface circuitry 34 having appropriate ports (36, 37 & 38) for connecting the trusted device 24 respectively to the data bus 26, control lines 27 and address lines 28 of the motherboard 20. Each of the blocks in the trusted device 24 has access (typically via the controller 30) to appropriate volatile memory areas 4 and/or non-volatile memory areas 3 of the trusted device 24. Additionally, the trusted device 24 is designed, in a known manner, to be tamper resistant.

For reasons of performance, the trusted device 24 may be implemented as an application specific integrated circuit (ASIC). However, for flexibility, the trusted device 24 is preferably an appropriately programmed micro-controller. Both ASICs and micro-controllers are well known in the art of microelectronics and will not be considered herein in any further detail.

One item of data stored in the non-volatile memory 3 of the trusted device 24 is a certificate 350. The certificate 350 contains at least a public key 351 of the trusted device 24 and an authenticated value 352 of the platform integrity metric measured by a trusted party (TP). The certificate 350 is signed by the TP using the TP's private key prior to it being stored in the trusted device 24. In later communications sessions, a user of the platform 10 can deduce that the public key belongs to a trusted device by verifying the TP's signature on the certificate. Also, a user of the platform 10 can verify the integrity of the platform 10 by comparing the acquired integrity metric with the authentic integrity metric 352. If there is a match, the user can be confident that the platform 10 has not been subverted. Knowledge of the TP's generally-available public key enables simple verification of the certificate 350. The non-volatile memory 35 also contains an identity (ID) label 353. The ID label 353 is a conventional ID label, for example a serial number, that is unique within some context. The ID label 353 is generally used for indexing and labelling of data relevant to the trusted device 24, but is insufficient in itself to prove the identity of the platform 10 under trusted conditions.

The trusted device 24 is equipped with at least one method of reliably measuring or acquiring the integrity metric of the computing platform 10 with which it is associated. In this embodiment of a Personal Computer, a first integrity metric is acquired by the measurement function 31 in a process involving the generation of a digest of the BIOS instructions in the BIOS memory. Such an acquired integrity metric, if verified as described above, gives a potential user of the platform 10 a high level of confidence that the platform 10 has not been subverted at a hardware, or BIOS program, level. Other known processes, for example virus checkers, will typically be in place to check that the operating system and application program code has not been subverted.

The measurement function 31 has access to: non-volatile memory 3 for storing a hash program 354 and a private key 355 of the trusted device 24, and volatile memory 4 for storing acquired integrity metrics. A trusted device has limited memory, yet it may be desirable to store information relating to a large number of integrity metric measurements. This is done in trusted computing platforms as described by the Trusted Computing Group by the use of Platform Configuration Registers (PCRs) 8a-8n. The trusted device has a number of PCRs of fixed size (the same size as a digest)—on initialisation of the platform, these are set to a fixed initial value. Integrity metrics are then “extended” into PCRs by a process shown in FIG. 4. The PCR 8i value is concatenated 403 with the input 401 which is the value of the integrity metric to be extended into the PCR. The concatenation is then hashed 402 to form a new 160 bit value. This hash is fed back into the PCR to form its new value. In addition to the extension of the integrity metric into the PCR, to provide a clear history of measurements carried out the measurement process may also be recorded in a conventional log file (which may be simply in main memory of the computer platform). For trust purposes, it is the PCR value that will be relied on and not the software log—the PCR value may indeed be used to verify the software log.

Clearly, there are a number of different ways in which an initial integrity metric may be calculated, depending upon the scope of the trust required. The measurement of the BIOS program's integrity provides a fundamental check on the integrity of a platform's underlying processing environment. The integrity metric should be of such a form that it will enable reasoning about the validity of the boot process—the value of the integrity metric can be used to verify whether the platform booted using the correct BIOS. Optionally, individual functional blocks within the BIOS could have their own digest values, with an ensemble BIOS digest being a digest of these individual digests. This enables a policy to state which parts of BIOS operation are critical for an intended purpose, and which are irrelevant (in which case the individual digests must be stored in such a manner that validity of operation under the policy can be established).

Other integrity checks could involve establishing that various other devices, components or apparatus attached to the platform are present and in correct working order. In one example, the BIOS programs associated with a SCSI controller could be verified to ensure communications with peripheral equipment could be trusted. In another example, the integrity of other devices, for example memory devices or co-processors, on the platform could be verified by enacting fixed challenge/response interactions to ensure consistent results. As indicated above, a large number of integrity metrics may be collected by measuring agents directly or indirectly measured by the RTM, and these integrity metrics extended into the PCRs of the trusted device 24. Some—many—of these integrity metrics will relate to the software state of the trusted platform.

Preferably, the BIOS boot process includes mechanisms to verify the integrity of the boot process itself. Such mechanisms are already known from, for example, Intel's draft “Wired for Management baseline specification v 2.0—BOOT Integrity Service”, and involve calculating digests of software or firmware before loading that software or firmware. Such a computed digest is compared with a value stored in a certificate provided by a trusted entity, whose public key is known to the BIOS. The software/firmware is then loaded only if the computed value matches the expected value from the certificate, and the certificate has been proven valid by use of the trusted entity's public key. Otherwise, an appropriate exception handling routine is invoked. Optionally, after receiving the computed BIOS digest, the trusted device 24 may inspect the proper value of the BIOS digest in the certificate and not pass control to the BIOS if the computed digest does not match the proper value—an appropriate exception handling routine may be invoked.

Processes of trusted computing platform manufacture and verification by a third party are briefly described, but are not of fundamental significance to the present invention and are discussed in more detail in Pearson identified above.

At the first instance (which may be on manufacture), a TP which vouches for trusted platforms, will inspect the type of the platform to decide whether to vouch for it or not. The TP will sign a certificate related to the trusted device identity and to the results of inspection—this is then written to the trusted device.

At some later point during operation of the platform, for example when it is switched on or reset, the trusted device 24 acquires and stores the integrity metrics of the platform. When a user wishes to communicate with the platform, he uses a challenge/response routine to challenge the trusted device 24 (the operating system of the platform, or an appropriate software application, is arranged to recognise the challenge and pass it to the trusted device 24, typically via a BIOS-type call, in an appropriate fashion). The trusted device 24 receives the challenge and creates an appropriate response based on the measured integrity metric or metrics—this may be provided with the certificate and signed. This provides sufficient information to allow verification by the user.

Values held by the PCRs may be used as an indication of trusted platform state. Different PCRs may be assigned specific purposes (this is done, for example, in Trusted Computing Group specifications). A trusted device may be requested to provide values for some or all of its PCRs (in practice a digest of these values—by a TPM_Quote command) and sign these values. As indicated above, data (typically keys or passwords) may be sealed (by a TPM_Seal command) against a digest of the values of some or all the PCRs into an opaque blob. This is to ensure that the sealed data can only be used if the platform is in the (trusted) state represented by the PCRs. The corresponding TPM_Unseal command performs the same digest on the current values of the PCRs. If the new digest is not the same as the digest in the opaque blob, then the user cannot recover the data by the TPM_Unseal command.

In the case, specifically, of the application of the methodologies described above to a platform such as that found in a mobile telephone, reference is made to the architecture shown in FIG. 6, which corresponds to the platform described above with reference to FIGS. 1 and 2, and a process as described with reference to FIGS. 3 to 5.

For the sake of generality a platform 100 is shown containing a single computing engine 102 that executes instructions. An architecture using multiple such engines, or hardware engines that do not execute instructions, is a simplification of an architecture containing a single computing engine that executes instructions and so is not described in detail here. The engine 102 is enhanced with hardware and/or software support that enforces three levels of privilege 200, 202, 204 as shown in FIG. 2 and, in more detail in FIG. 6 although this may be varied as appropriate for example by the inclusion of further levels of privilege. The roots-of-trust execute at the highest level of privilege LEVEL 0, either by virtue of hardware support or software design. The roots-of-trust include the components which perform the operations of the type described above, that is, a TPM 206, a trusted processing and storage element protected from unauthorised modification, a root-of-trust-for-measurement (RTM) 216, a kernel 208 that boots a selected compartment-OS 212. Compartment-OSs 212 and any additional mandatory security functions (which may, as discussed further below, be a mandatory compartment-OS which launches the MSF in turn) operate at the second highest level of privilege LEVEL 1, either by virtue of hardware support or kernel design, and are isolated from each other by virtue of hardware support or software design. Compartment OSs 212 create and manage respective isolated processing environments 214 that operate at the third highest level of privilege LEVEL 2, either by virtue of hardware support or compartment-OS design.

The TPM 206 thus behaves like existing TPMs, and provides protected storage, accumulates static and dynamic integrity measurements and reports integrity measurements, has an Endorsement Key, Attestation Identities, and so on. Similarly, the RTM 216 is arranged to measure the kernel 208 (and preferably the TPM 206 and even itself) and store the resultant integrity metrics in the TPM in a conventional manner, allowing the kernel 208 to build compartment-OSs 212, measure them, and store the integrity metrics in the TPM. However in an extension of existing systems particularly relevant to platforms requiring specific software for launch of certain processes, for example mobile telephones, the mandatory processes are also enforced either as a mandatory trusted OS (TOS) that executes mandatory security functions or as a specific mandatory security function.

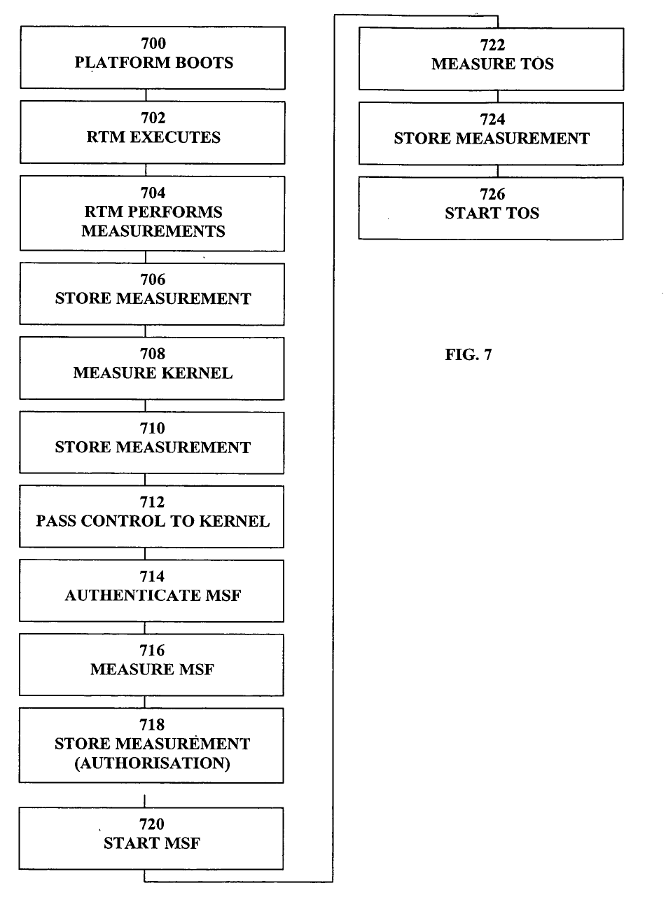

Operation of the method can be further understood with reference to the flow chart of FIG. 7. At step 700 the platform boots and at step 702 the RTM is the first process to execute. At step 704 the RTM measures itself and the TPM and in step 706 stores the result in static-PCRs (218 in FIG. 6) in the TPM. At step 708 the RTM then measures the kernel, storing the results in static-PCRs in the TPM in step 710. At step 712 the TPM passes control to the kernel

In step 714 the kernel 208 verifies authorisation information from a Trusted Third Party (TTP) that has authority over mandatory security functions. Typically the authorisation will be a certificate. The kernel does the verification by checking the signature on the certificate using a public key provided to the kernel 208 using an appropriate process which will be familiar to the skilled reader and is not described in detail here that introduces the TTP to the kernel 208. In step 716 the kernel measures any MSFs and compares the measurements with the authorisation information provided by the TTP and checked by the kernel. If the MSF measurement matches the authorisation information, in step 718 the kernel 208 stores the authorisation information in static PCRs 218 in the TPM 206, and in step 720 the kernel 208 starts any MSFs. At step 722 the kernel measures a TOS 212 for example upon user selection thereof, and, in step 724 stores the result in a static PCR in the TPM. In step 726 the kernel starts the TOS. It will be seen that the TOS, in contrast, may be launched in any appropriate manner, i.e. not as a mandatory process requiring a secure/enforced mode, or may be a mandatory TOS as discussed in more detail below.

In addition to providing security/enforcement and authorisation in relation to MSFs, the method described herein further permits management of the MSFs subsequently in exactly the same manner as any non-mandatory TOS, providing additional control and levels of trust. In particular, because of the storage of the authorisation information then additional authentication steps can be taken, as appropriate, instead of relying just upon the presence of the MSF by virtue of the secure boot process, as is existing practice. For example in the case that a third party wishes to interact with the mobile telephone then appropriate TCG integrity challenge authentication steps can be carried out to reliably discover the presence of the MSF. Similarly where data such as secrets is sealed against a PCR relating to the MSF then this data can only be used if the platform is in the appropriate trusted state.

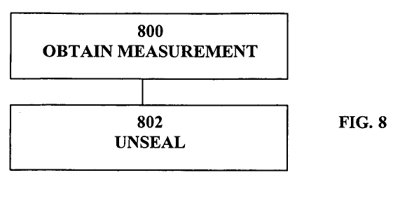

Accordingly, referring to FIG. 8, when further authentication (or other authorisation) is required, the appropriate measurement is retrieved at step 800. Then at step 802 the MSF and, as appropriate, the TOS obtain their secrets from the TPM using “unseal” as described in Pearson and also as described in more detail above, so that only the correct MSF or TOS can obtain its data including, for example, secrets used to identify each MSF/TOS and data associated with MSF/TOS customisation in previous boot cycle. For example this allows a computer platform to operate in a plurality of different states in a trustworthy manner as further described in the International patent application WO01/27722, entitled “Operation of Trust State and Computing Platform” and filed on 19^{th} Sep. 2000, the contents of which are incorporated by reference herein.

It will be appreciated that the kernel can launch a single OS or, in an optimisation, multiple compartmentalised OSs in the manner described, for example, in the applicants' GB patent application no. GB2382419, entitled “Creating a Trusted Environment using Integrity Metrics” filed on 22^{nd} Nov. 2001, the contents of which are incorporated by reference herein. Each compartment OS or trusted OS comprises at least one isolated compartment within the platform which can only be accessed via the kernel. This approach is extended to the MSF to ensure correct, secure and authenticated operation and inter-operation. In this case a policy is put into place to ensure that interaction is permitted for example in the manner described in the applicants' International patent application no. WO00/48063, the contents of which are incorporated by reference herein.

In particular each TOS creates and manages isolated processing environments and gives each such compartment its own isolated thread of resources. Each TOS potentially participates in webs of such compartments, which may or may not be on different platforms as described in the applicants' European patent application published under no. EP1280042, the contents of which are incorporated by reference herein. For each such compartment in its own platform a TOS preferably consults the appropriate policy to create an “enforcement list” of processes and compartments permitted to view certain aspects. The list is enforced by enforcement mechanisms in the TOS and includes permissions in relation to the input to the TOS compartment, the TOS compartment thread, the TOS compartment output and the TOS compartment audit data.

The TOS is able to measure the lists and either store the resultant integrity metrics in a dynamic PCR in the TPM or in a dynamic PCR that it itself provides. It will be seen that the use of “enforcement lists” is applied equally to the MSF providing additional control of launch and interaction with the MSF.

In addition, it is possible that the MSF, rather than being launched directly by the kernel, can be launched by a mandatory TOS acting as a mandatory process, that is to say, a mandatory compartmentalised operation system itself launched under enforced secure and authenticated (in any event, appropriately authorised) circumstances by the kernel. The mandatory TOS then launches the MSF with the level of trust being maintained. In that case launch can be managed in the same manner that a TOS would start an application process or a child OS in one of its compartments. Namely the TOS unseals the data belonging to the application/child according to the dynamic-PCRs (recording the compartment's processes, thread (resources) and enforcement list) in the TPM or the TOS-TPM (a virtual TPM within the compartment itself), and according to the static PCRs in the TPM. Hence, only the correct processes, isolated in the required manner and connected in the required manner, are able to access the secrets whose use is determined by policies ensuring that the MSF is launched only in the required manner.

It will be seen that the various approaches described above are advantageous in relation to mobile telephones but can be equally applied to other mobile platforms and indeed any computing platform which supports or requires an MSF. In addition to obtaining secure and enforced boot for such functions, the manner in which it boots and operates is also recorded such that the information can be used in the platform or by external processes. In addition as the MSF is launched and enforced in the same manner as a TOS or indeed under the control of a TOS, simple integration into trusted platform architecture is permitted.

It will be appreciated that the system can be embodied in any appropriate form, for example on a single programmable chip or as an SOC (system on a chip) operating in appropriate trusted mode in conjunction with a radio chip in the case of a mobile telephone and in any other appropriate isolating processing environment whether on a separate chip or not.

The approach can also be applied in relation to any MSF such as mandatory software controlling network connection or communication protocol, an enforced trusted human input-output system or any other function that must be controlled by a specific software process and/or operate in a specific way. Furthermore the method described herein permits certain processes to operate as MSFs and other processes to provide more freedom such that for example those other aspects may boot in any desired way and under control of any desired process.

1. A method for creating a trusted environment in a computing platform comprising the steps, performed by a trusted device, of:
obtaining authorisation information in relation to a process having a mandatory manner of launch;
launching the mandatory function if the authorisation information meets an authorisation criterion; and
storing the authorisation information for additional authorisation steps.

2. A method as claimed in claim 1 in which the computing platform comprises a mobile platform.

3. A method as claimed in claim 2 in which the mobile platform comprises a mobile telephone.

4. A method as claimed in claim 1 in which the mandatory process comprises a mandatory security function (MSF).

5. A method as claimed in claim 4 in which the MSF comprises control of radio communication.

6. A method as claimed in claim 1 in which the mandatory process includes a mandatory trusted operating system (TOS) arranged to launch a mandatory function comprising part of the trusted device, in which the trusted device further performs the steps of:
obtaining authorisation information relating to the TOS; and
launching the TOS if the authorisation information meets an authorisation criterion prior to launch of the mandatory function.

7. A method as claimed in claim 1 in which the trusted device further carries out the steps of obtaining authorisation information relating to a non-mandatory process, launching the non-mandatory process if the authorisation information meets an authorisation criterion and storing the authorisation information for additional authorisation steps.

8. A method as claimed in claim 7 in which the non-mandatory process comprises a non-mandatory trusted operating system.

9. A method as claimed in claim 1 in which the additional authorisation steps comprise at least one of an unseal operation or interaction with a third party.

10. A method as claimed in claim 1 in which the mandatory process further stores details of system components permitted access to mandatory process data.

11. A method as claimed in claim 10 in which the system components comprise at least one of operating systems and other mandatory processes.

12. A method as claimed in claim 10 in which the mandatory process data includes at least one of input to the mandatory process, mandatory process resources, mandatory process output and mandatory process audit data.

13. A method for creating a trusted environment in a computing platform comprising the steps, performed by a trusted device, of:
obtaining authorisation information in relation a process having a mandatory manner of launch;
launching the mandatory process in the mandatory manner if the authorisation information meets an authorisation criterion;
obtaining authorisation information in relation to a process having a non-mandatory manner of launch; and
launching the non-mandatory process if the authorisation information meets an authorisation criterion.

14. A computer apparatus for creating a trusted environment, comprising a trusted device arranged to launch a mandatory process in a mandatory manner, in which the trusted device is arranged to obtain authorisation information relating to a mandatory process, launch the mandatory process in the mandatory manner if the authorisation information meets an authorisation criterion, and store authorisation information for additional authorisation steps.

15. A trusted device for creating a trusted environment in a computer platform in which the trusted device is arranged to obtain authorisation information relating to a mandatory process requiring launch in a mandatory manner, launch the mandatory process in the mandatory manner if the authorisation information meets an authorisation criterion, and store the authorisation information for additional authorisation steps.

16. A computer readable medium containing instructions arranged to operate a processor to implement the method of claim 1.

17. An apparatus for creating a trusted environment comprising a processor configured to operate under instructions contained in a computer readable medium to implement the method of claim 1.
